(19) United States
(12) Patent Application Publication
(10) Pub. No.: US 2026/0313637 A1
(43) Pub. Date: Oct. 8, 2026

(54) LATENCY-SENSITIVE TRAFFIC NEGOTIATION METHOD, ELECTRONIC DEVICE, AND STORAGE MEDIUM

(71) Applicant: BEIJING XIAOMI MOBILE SOFTWARE CO., LTD., Beijing (CN)

(72) Inventor: Yajun CHENG, Beijing (CN)

(73) Assignee: BEIJING XIAOMI MOBILE SOFTWARE CO., LTD., Beijing (CN)

(21) Appl. No.: 19/484,581

(22) PCT Filed: May 19, 2023
(86) PCT No.: PCT/CN2023/095389

§ 371 Date: Nov. 14, 2025

(51) Int. Cl. H04W 72/1263; H04W 52/02; H04W 76/14

(52) U.S. Cl. CPC H04W 72/1263; H04W 52/0216; H04W 76/14

(57) ABSTRACT

A negotiation method for a latency sensitive traffic, applied to an access point (AP) device, includes: determining a first wireless frame, in which the first wireless frame comprises first identifier information, and the first identifier information comprises: a time parameter for transmitting the latency sensitive traffic between tunneled direct link setup (TDLS) devices via a TDLS link within a restricted target wake time (R-TWT) service period (SP) of an R-TWT schedule; and sending the first wireless frame.

### CROSS REFERENCE TO RELATED APPLICATIONS

This application is a U.S. National Phase of International Application No. PCT/CN2023/095389, filed with the State Intellectual Property Office of P. R. China on May 19, 2023, the entire contents of which are incorporated herein by reference.

### TECHNICAL FIELD

The present disclosure relates to the field of mobile communication technology, and specifically to a negotiation method for a latency sensitive traffic, an electronic device, and a storage medium.

### BACKGROUND

In currently researched wireless-fidelity (Wi-Fi) technology, the target wake time (TWT) mechanism has been proposed to support energy-saving operations for large scale internet of things (IoT) devices, at the same time. Concurrently, the restricted target wake time (R-TWT) mechanism has been introduced to ensure the transmission of latency sensitive traffic. To further reduce power consumption in Wi-Fi networks, the R-TWT mechanism requires to be improved to guarantee the transmission of the latency sensitive traffic.

### SUMMARY

According to one aspect, the embodiments of the present disclosure provide a negotiation method for a latency sensitive traffic, applied to an access point (AP) device, including: determining a first wireless frame, in which the first wireless frame includes first identifier information, and the first identifier information includes: a time parameter for transmitting the latency sensitive traffic between tunneled direct link setup (TDLS) devices via a TDLS link within an R-TWT service period (SP) of an R-TWT schedule; and sending the first wireless frame.

According to another aspect, the embodiments of the present disclosure further provide a negotiation method for a latency sensitive traffic, applied to a TDLS device, including: receiving a first wireless frame, in which the first wireless frame includes first identifier information, and the first identifier information includes: a time parameter for transmitting the latency sensitive traffic between TDLS devices via a TDLS link within an R-TWT SP of an R-TWT schedule.

The embodiments of the present disclosure further provide an electronic device, including: a memory, a processor, and a computer program stored on the memory and executable by the processor, in which the processor, when executing the computer program, implements one or more of the methods described in the embodiments of the present disclosure.

The embodiments of the present disclosure further provide a non-transitory computer-readable storage medium for storing a computer program that, when executed by a processor, causes the processor to implement one or more of the methods described in the embodiments of the present disclosure.

### BRIEF DESCRIPTION OF THE DRAWINGS

To clearly illustrate technical solutions of embodiments of the present disclosure, a brief description of drawings used in embodiments is given below. Obviously, the drawings in the following descriptions are only part embodiments of the present disclosure, and for those skilled in the art, other drawings may be obtained according to these drawings without creative labor.

FIG. 1 is a schematic diagram one according to the embodiments of the present disclosure.

FIG. 2 is a schematic diagram two according to the embodiments of the present disclosure.

FIG. 3 is a schematic diagram three according to the embodiments of the present disclosure.

FIG. 4 is a flowchart one of a negotiation method for a latency sensitive traffic provided by the embodiments of the present disclosure.

FIG. 5 is a flowchart two of a negotiation method for a latency sensitive traffic provided by the embodiments of the present disclosure.

FIG. 6 is a block diagram one of an electronic device provided by the embodiments of the present disclosure.

FIG. 7 is a block diagram two of an electronic device provided by the embodiments of the present disclosure.

FIG. 8 is a block diagram three of an electronic device provided by the embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the embodiments of the present disclosure as recited in the appended claims.

The term used in the present disclosure is merely for describing a detailed embodiment, and is not intended to limit the present disclosure. As used in the present disclosure and the appended claims, singular forms “a/an” and “the” are also intended to include plural forms, unless the context clearly indicates other meaning. It should also be understood that, the term “and/or” as used herein refers to including any or all possible combinations of one or more associated listed items. For example, A and/or B may represent three cases, that is, A alone, A and B simultaneously, and B alone. The character “/” generally represents that there is an “or” relationship between related objects. The term “a plurality of” means two or more. Therefore, in the embodiments of the present disclosure, “a plurality of” may also be understood as “at least two”.

Although the terms first, second, third, etc. may be used to describe various information in the present disclosure, such information should not be limited to these terms. These terms are used only to distinguish information in the same type from one another. For example, without departing from the scope of the embodiments of the present disclosure, the first information may also be referred to as the second information, and similarly, the second information may be referred to as the first information. Depending on the context, words “if” and “in case that” used here may be interpreted as “when”, “while”, or “in response to determining . . . ”.

Technical solutions in the embodiments of the present disclosure will be clearly and completely described below with reference to the accompanying drawings in the embodiments of the present disclosure. Obviously, the embodiments described here are only part of the embodiments of the present disclosure and are not all embodiments of the present disclosure. Based on the embodiments of the present disclosure, other embodiments obtained by those skilled in the art without creative labor are within the scope of the present disclosure.

The embodiments of the present disclosure provide a negotiation method for a latency sensitive traffic, an electronic device, and a storage medium, used to further improve a restricted target wake time (R-TWT) mechanism and guarantee transmission of the latency sensitive traffic.

The method and the device are based on a same application idea. Since principles of the method and the apparatus for solving a problem are similar, implementations of the apparatus and the method may be referred to each other, which is not repeated here.

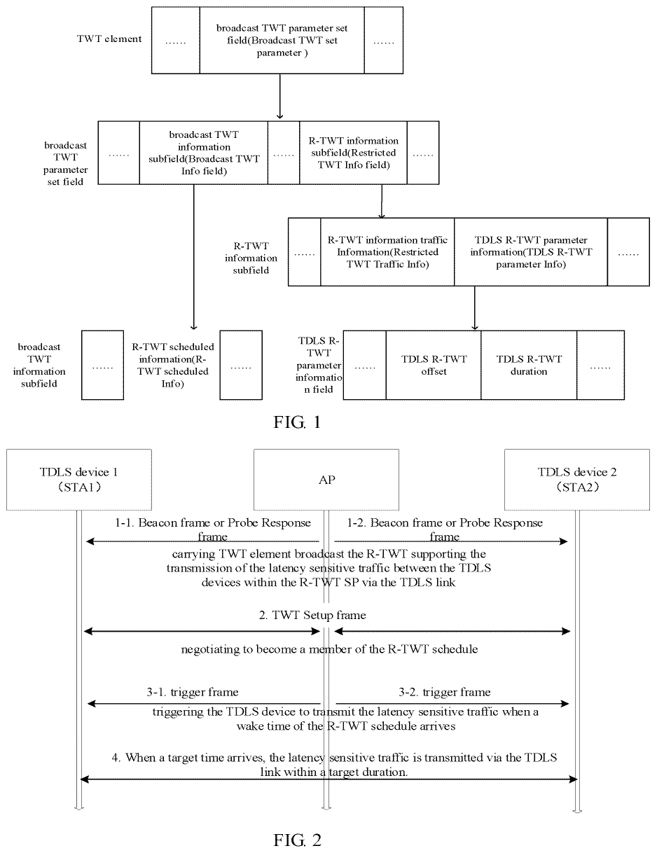

Referring to FIG. 1, FIG. 1 is a schematic diagram of a part of the structure of the negotiation method for a latency sensitive traffic provided by various embodiments of the present disclosure.

An access point (AP) device broadcasts, via a first wireless frame, a time parameter for transmitting the latency sensitive traffic between tunneled direct link setup (TDLS) devices via a TDLS link within an R-TWT service period (SP) of an R-TWT schedule. The TDLS device negotiates with the AP via a target wake time (TWT) setup frame and joins to become a member of a R-TWT schedule.

Optionally, the AP is, for example, a device with a wireless-to-wired bridging functionality. The AP is responsible for extending a service provided by a wired network to a wireless network. The TDLS device is, for example, a station (STA) device. The STA is, for example, an electronic device with a wireless network access functionality, provids a frame delivery service to enable transmission of information.

Specifically, the AP determines and sends the first wireless frame, in which the first wireless frame includes first identifier information, and the first identifier information includes: a time parameter for transmitting the latency sensitive traffic between TDLS devices via a TDLS link within an R-TWT SP of an R-TWT schedule, in which the time parameter is, for example, a start time, a duration, etc., within the R-TWT SP, for transmitting the latency sensitive traffic between TDLS devices via the TDLS link.

Optionally, as shown in FIG. 1, the first identifier information is, for example, shown in a TDLS R-TWT parameter information field, and the time parameter includes at least one piece of TDLS R-TWT offset information and/or TDLS R-TWT duration information, used to identify relevant time information for transmitting the latency sensitive traffic between the TDLS devices via the TDLS link, which facilitates the transmission of the latency sensitive traffic between the TDLS devices via the TDLS link according to the relevant time information.

Specifically, the TDLS R-TWT offset information identifies: within the R-TWT SP, a target offset time of a start time for transmitting the latency sensitive traffic between the TDLS devices via the TDLS link relative to a start time of the R-TWT SP. For example, if the start time of the R-TWT SP is T1 and the target offset time is T2, then the start time for allowing the transmission of the latency sensitive traffic between the TDLS devices via the TDLS link is T3=T1+T2.

The TDLS R-TWT duration information identifies: within the R-TWT SP, a target duration for transmitting the latency sensitive traffic between the TDLS devices via the TDLS link, in which the target duration may be used by the TDLS device to determine an end time for transmitting the latency sensitive traffic. For example, if the start time for allowing the transmission of the latency sensitive traffic between the TDLS devices via the TDLS link is T3 and the target duration is D1, then the end time for allowing the transmission of the latency sensitive traffic between the TDLS devices via the TDLS link is T4=T3+DI.

Optionally, as shown in FIG. 1, the first wireless frame includes a TWT element; the TWT element includes: a broadcast TWT parameter set field; the broadcast TWT parameter set field includes: an R-TWT information subfield; and the first identifier information is carried in the R-TWT information subfield, and is used to identify relevant time information for transmitting the latency sensitive traffic between the TDLS devices via the TDLS link.

It may be understood that the TWT element in FIG. 1 and various fields and subfields of the TWT element only show a part of content. Take the TWT element as an example, the TWT element also includes other fields not shown in FIG. 1, such as an element ID field, a length control field, a TWT parameter information field, etc., and other content that is not shown should also be understood as content possessed by the TWT element.

Optionally, as shown in FIG. 1, the first identifier information may include TDLS R-TWT parameter information.

Furthermore, as shown in FIG. 1, the broadcast TWT parameter set field also includes: a broadcast TWT information subfield; the broadcast TWT information subfield includes: an R-TWT schedule information subfield; and the R-TWT schedule information subfield is set to a first parameter value, indicating that the R-TWT schedule supports transmitting the latency sensitive traffic between the TDLS devices within the R-TWT SP via the TDLS link.

Furthermore, as shown in FIG. 2, FIG. 2 shows a schematic diagram of an application scenario of the negotiation method for a latency sensitive traffic in the embodiments of the present disclosure, in which the first wireless frame includes a beacon frame or a probe response frame.

The AP performs step 1 (1-1, 1-2, . . . , 1-n, each sub-step may be performed simultaneously or sequentially), sends the first wireless frame (beacon frame or probe response frame) to STA1 (TDLS device 1) and STA2 (TDLS device 2), and carries the TWT element in the first wireless frame.

The TWT element includes:
(1) a R-TWT schedule information subfield in the TWT parameter field: used to identify whether a corresponding R-TWT schedule supports transmitting the latency sensitive traffic between the TDLS devices within a corresponding SP via the TDLS link. For example, the corresponding R-TWT schedule may be identified by setting a value of the R-TWT schedule information subfield to 4;
(2) a TDLS R-TWT offset value is set to: an offset time of a start time for transmitting the latency sensitive traffic between the TDLS devices via the TDLS link within a corresponding R-TWT SP, relative to a start time of the corresponding R-TWT SP;
(3) a TDLS R-TWT duration is set to: a duration for transmitting the latency sensitive traffic between the TDLS devices via the TDLS link within the corresponding R-TWT SP.

Step 2: The TDLS device and the AP negotiate via a TWT setup frame, and the TDLS device may join an R-TWT schedule broadcast by the AP to become a member of the corresponding R-TWT schedule.

Step 3 (3-1, 3-2): When a wake time of the R-TWT schedule joined by the TDLS device arrives, the AP sends a basic trigger frame to a corresponding R-TWT member (TDLS device) to trigger the member of the R-TWT schedule to send the latency sensitive traffic.

Step 4: When a target time arrives, the latency sensitive traffic is transmitted via the TDLS link within a target duration.

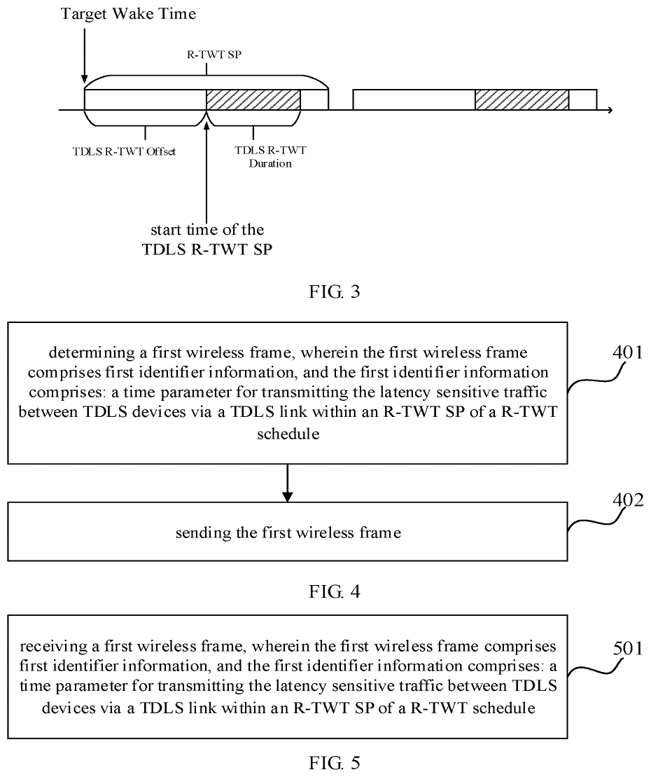

As shown in FIG. 3, when a TWT of the R-TWT arrives, the R-TWT SP starts, and the latency sensitive traffic is transmitted between the R-TWT member and the AP. Within the R-TWT SP, when a TDLS R-TWT offset time relative to the target wake time arrives, a direct link latency sensitive traffic transmission time between the TDLS devices starts, and the R-TWT schedule member directly performs latency sensitive traffic transmission via an established TDLS link within the TDLS R-TWT duration.

In the embodiments of the present disclosure, the R-TWT SP is not only used for latency sensitive traffic transmission between an AP of an R-TWT schedule and a member STA of the R-TWT schedule, but also supports the member STA of the R-TWT schedule to transmit the latency sensitive traffic via the TDLS link within the TDLS R-TWT duration. Based on the R-TWT mechanism, a periodic target wake-up mechanism effectively guarantees transmission of a deterministic latency sensitive traffic and improves transmission efficiency of a latency sensitive communication traffic. In addition, based on the TDLS link, communication between STAs is achieved without an AP. This peer to peer (P2P) communication method performs data transmission without an AP, which avoids a latency caused by network congestion, reduces energy consumption of a terminal, and improves efficiency of the data transmission. The embodiments of the present disclosure provide a negotiation method for a latency sensitive traffic, to further improve the R-TWT mechanism and guarantee the latency sensitive traffic transmission.

Referring to FIG. 4, the embodiments of the present disclosure provide a negotiation method for a latency sensitive traffic, applied to an AP device. The method includes steps at S401 to S402.

At S401, a first wireless frame is determined, in which the first wireless frame includes first identifier information, and the first identifier information includes: a time parameter for transmitting the latency sensitive traffic between TDLS devices via a TDLS link within an R-TWT SP of an R-TWT schedule.

At S402, the first wireless frame is sent.

TWT is a technology used for energy saving, aiming to further reduce power consumption of a Wi-Fi network. Specifically, the TWT technology enables the STA and the AP to negotiate an SP to determine a sleep time, a wake time and a frequency of the STA. The STA remains active within the SP and communicates with others, thus allowing the STA to sleep outside the SP to achieve energy saving. In addition, the TWT technology may also enable the AP to provide a higher quality service to a plurality of STAs, which minimizes competition or overlap, and improves spectrum efficiency while reducing the power consumption of the Wi-Fi network.

In a latency sensitive transmission scenario, real-time data traffic of many applications has strict latency requirements, for example, magnitude of an average latency or a maximum latency is between several milliseconds to tens of milliseconds, and applications require the real-time data traffic to have minimal jitter and strong reliability. To further ensure the latency sensitive traffic communication, the R-TWT is proposed based on the TWT technology. The R-TWT mechanism allows the AP to use an enhanced media access protection mechanism and a resource reservation mechanism to provide more predictable latency, to distinguish the latency sensitive traffic from other types of traffic, which enables the AP to minimize worst-case latency and/or reduce jitter, and provide more reliable services.

In the embodiments of the present disclosure, the AP determines and sends the first wireless frame, in which the first wireless frame includes first identifier information, and the first identifier information includes: a time parameter for transmitting the latency sensitive traffic between TDLS devices via a TDLS link within an R-TWT SP of an R-TWT schedule, in which the time parameter is, for example, a start time, a duration, etc., within the R-TWT SP, for transmitting the latency sensitive traffic between TDLS devices via the TDLS link.

Optionally, in the embodiments of the present disclosure, the time parameter includes: TDLS R-TWT offset information and/or TDLS R-TWT duration information, in which the TDLS R-TWT offset information identifies: within the R-TWT SP, a target offset time of a start time for transmitting the latency sensitive traffic between the TDLS devices via the TDLS link relative to a start time of the R-TWT SP. For example, if the start time of the R-TWT SP is T1 and the target offset time is T2, then the start time for allowing the transmission of the latency sensitive traffic between the TDLS devices via the TDLS link is T3=T1+T2.

The TDLS R-TWT duration information identifies: within the R-TWT SP, a target duration for transmitting the latency sensitive traffic between the TDLS devices via the TDLS link, in which the target duration may be used by the TDLS device to determine an end time for transmitting the latency sensitive traffic. For example, if the start time for allowing the transmission of the latency sensitive traffic between the TDLS devices via the TDLS link is T3 and the target duration is D1, then the end time for allowing the transmission of the latency sensitive traffic between the TDLS devices via the TDLS link is T4=T3+D1.

Optionally, in the embodiments of the present disclosure, the first wireless frame includes a TWT element; the TWT element includes: a broadcast TWT parameter set field; the broadcast TWT parameter set field includes: an R-TWT information subfield; and the first identifier information is carried in the R-TWT information subfield, and is used to identify relevant time information for transmitting the latency sensitive traffic between the TDLS devices via the TDLS link.

Optionally, in the embodiments of the present disclosure, the first identifier information includes TDLS R-TWT parameter information.

Optionally, in the embodiments of the present disclosure, as shown in FIG. 1, the broadcast TWT parameter set field includes: a broadcast TWT information subfield; the broadcast TWT information subfield includes: an R-TWT schedule information subfield; and the R-TWT schedule information subfield is set to a first parameter value, indicating that the R-TWT schedule supports transmitting the latency sensitive traffic between the TDLS devices within the R-TWT SP via the TDLS link.

Optionally, in the embodiments of the present disclosure, the first wireless frame includes a beacon frame or a probe response frame.

Optionally, in the embodiments of the present disclosure, the method includes: receiving and responding to a first TWT setup frame sent by a TDLS device; in which TWT request identifier information of the first TWT setup frame indicates that the first TWT setup frame is a TWT setup request, and the first TWT setup frame indicates that the TDLS device requests to become a member of the R-TWT schedule.

As shown in FIG. 2, the TDLS device and the AP negotiate via a TWT setup frame, and the TDLS device may join an R-TWT schedule broadcast by the AP to become a member of the corresponding R-TWT schedule.

Optionally, in the embodiments of the present disclosure, after receiving and responding to the TWT setup frame sent by the TDLS device, the method includes: when a wake time of the R-TWT schedule arrives, sending a trigger frame to the TDLS device, in which the trigger frame triggers the TDLS device to transmit the latency sensitive traffic.

As shown in step 3 (3-1, 3-2) of FIG. 2, when the wake time of the R-TWT schedule joined by the TDLS device arrives, the AP sends the basic trigger frame to the corresponding R-TWT member (TDLS device) to trigger the member of the R-TWT schedule to send the latency sensitive traffic.

In the embodiments of the present disclosure, the AP determines the first wireless frame, in which the first wireless frame includes the first identifier information, and the first identifier information includes: the time parameter for transmitting the latency sensitive traffic between the TDLS devices via the TDLS link within the R-TWT SP of the R-TWT schedule, so that the R-TWT SP is not only used for latency sensitive traffic transmission between an AP of a R-TWT schedule and a member STA of the R-TWT schedule, but also supports the member STA of the R-TWT schedule to transmit the latency sensitive traffic via the TDLS link within the TDLS R-TWT duration. Based on the R-TWT mechanism, a periodic target wake-up mechanism effectively guarantees transmission of a deterministic latency sensitive traffic and improves transmission efficiency of a latency sensitive communication traffic. In addition, based on the TDLS link, communication between STAs is achieved without an AP. This P2P communication method performs data transmission without an AP, which avoids a latency caused by network congestion, reduces energy consumption of a terminal, and improves efficiency of the data transmission.

Referring to FIG. 5, the embodiments of the present disclosure provide a negotiation method for a latency sensitive traffic. Optionally, the method may be applied to a TDLS device, and may include a following step at S501.

At S501, a first wireless frame is received, in which the first wireless frame includes first identifier information, and the first identifier information includes: a time parameter for transmitting the latency sensitive traffic between TDLS devices via a TDLS link within an R-TWT SP of an R-TWT schedule.

The TDLS device receives the first wireless frame, obtains the first identifier information included in the first wireless frame, and determines, via the first identifier information, the time parameter for transmitting the latency sensitive traffic between the TDLS devices via the TDLS link within the R-TWT SP of the R-TWT schedule, in which the time parameter is, for example, a start time, a duration, etc., within the R-TWT SP, for transmitting the latency sensitive traffic between TDLS devices via the TDLS link.

Optionally, in the embodiments of the present disclosure, the time parameter includes: TDLS R-TWT offset information and/or TDLS R-TWT duration information, in which the TDLS R-TWT offset information identifies: within the R-TWT SP, a target offset time of a start time for transmitting the latency sensitive traffic between the TDLS devices via the TDLS link relative to a start time of the R-TWT SP. For example, if the start time of the R-TWT SP is T1 and the target offset time is T2, then the start time for allow the transmission of the latency sensitive traffic between the TDLS devices via the TDLS link is T3=T1+T2.

The TDLS R-TWT duration information identifies: within the R-TWT SP, a target duration for transmitting the latency sensitive traffic between the TDLS devices via the TDLS link, in which the target duration may be used by the TDLS device to determine an end time for transmitting the latency sensitive traffic. For example, if the start time for allowing the transmission of the latency sensitive traffic between the TDLS devices via the TDLS link is T3 and the target duration is D1, then the end time for allowing the transmission of the latency sensitive traffic between the TDLS devices via the TDLS link is T4=T3+DI.

Optionally, in the embodiments of the present disclosure, the first wireless frame includes a TWT element; the TWT element includes: a broadcast TWT parameter set field; the broadcast TWT parameter set field includes: an R-TWT information subfield; and the first identifier information is carried in the R-TWT information subfield, and is used to identify relevant time information for transmitting the latency sensitive traffic between the TDLS devices via the TDLS link.

Optionally, in the embodiments of the present disclosure, the first identifier information includes TDLS R-TWT parameter information.

Optionally, in the embodiments of the present disclosure, the broadcast TWT parameter set field includes: a broadcast TWT information subfield; the broadcast TWT information subfield includes: an R-TWT schedule information subfield; and the R-TWT schedule information subfield is set to a first parameter value, indicating that the R-TWT schedule supports transmitting the latency sensitive traffic between the TDLS devices within the R-TWT SP via the TDLS link.

Optionally, in the embodiments of the present disclosure, the first wireless frame includes a beacon frame or a probe response frame.

Optionally, in the embodiments of the present disclosure, the method includes: sending a first TWT setup frame to an AP device, in which TWT request identifier information of the first TWT setup frame indicates that the first TWT setup frame is a TWT setup request; and the first TWT setup frame indicates that the TDLS device requests to become a member of the R-TWT schedule; and receiving a second TWT setup frame fed back from the AP device, in which TWT request identifier information of the second TWT setup frame indicates that the second TWT setup frame is a TWT setup response; and the second TWT setup frame is sent in response to the first TWT setup frame. As shown in FIG. 2, the TDLS device and the AP negotiate via a TWT setup frame, and the TDLS device may join an R-TWT schedule broadcast by the AP to become a member of the corresponding R-TWT schedule.

Optionally, in the embodiments of the present disclosure, after receiving the second TWT setup frame fed back from the AP device, the method includes: receiving a trigger frame sent by the AP device, in which the trigger frame triggers the TDLS device to transmit the latency sensitive traffic. As shown in step 3 (3-1, 3-2) of FIG. 2, when the wake time of the R-TWT schedule joined by the TDLS device arrives, the AP sends the basic trigger frame to the corresponding R-TWT member (TDLS device) to trigger the R-TWT schedule member to send the latency sensitive traffic.

Optionally, in the embodiments of the present disclosure, after receiving the second TWT setup frame fed back from the AP device, the method includes: when a target time arrives, within the target duration, transmitting the latency sensitive traffic via the TDLS link, in which the target time is a time after the start time of the R-TWT SP is offset by the target offset time.

As shown in FIG. 3, when a TWT of the R-TWT arrives, the R-TWT SP starts, and the latency sensitive traffic is transmitted between the R-TWT member and the AP. Within the R-TWT SP, when a TDLS R-TWT offset time relative to the target wake time arrives, a direct link latency sensitive traffic transmission time between the TDLS devices starts, and the members of the R-TWT schedule directly perform latency sensitive traffic transmission via an established TDLS link within the TDLS R-TWT duration.

In the embodiments of the present disclosure, the STA receives the first wireless frame, and obtains the first identifier information carried in the first wireless frame. The first identifier information includes: a time parameter for transmitting the latency sensitive traffic between TDLS devices via a TDLS link within an R-TWT SP of an R-TWT schedule, so that the R-TWT SP is not only used for latency sensitive traffic transmission between an AP of the R-TWT schedule and a member STA of the R-TWT schedule, but also supports the member STA of the R-TWT schedule to transmit the latency sensitive traffic via the TDLS link within the TDLS R-TWT duration.

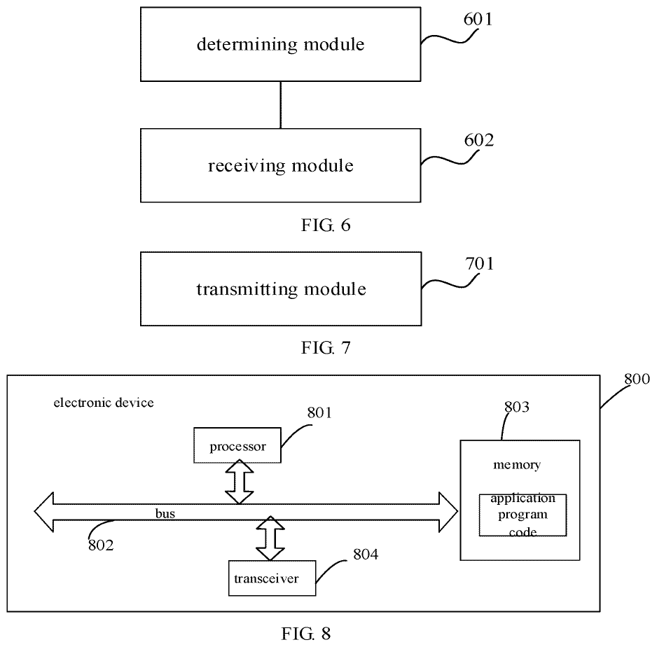

Referring to FIG. 6, based on the same principle as the method provided by the embodiments of the present disclosure, the embodiments of the present disclosure further provide an electronic device, in which the electronic device is a TDLS device, including; a determining module 601, configured to determine a first wireless frame, in which the first wireless frame includes first identifier information, and the first identifier information includes: a time parameter for transmitting the latency sensitive traffic between TDLS devices via a TDLS link within an R-TWT SP of an R-TWT schedule; and a sending module 602, configured to send the first wireless frame.

The embodiments of the present disclosure further provide a negotiation apparatus for a latency sensitive traffic, applied to a TDLS device, including: a wireless frame determining module, configured to determine a first wireless frame, in which the first wireless frame includes first identifier information, and the first identifier information includes: a time parameter for transmitting the latency sensitive traffic between TDLS devices via a TDLS link within an R-TWT SP of an R-TWT schedule; and a wireless frame sending module, configured to send the first wireless frame.

Referring to FIG. 7, based on the same principle as the method provided by the embodiments of the present disclosure, the embodiments of the present disclosure further provide an electronic device, in which the electronic device is a TDLS device, including: a wireless frame receiving module 701, configured to receive a first wireless frame, in which the first wireless frame includes first identifier information, and the first identifier information includes: a time parameter for transmitting the latency sensitive traffic between TDLS devices via a TDLS link within an R-TWT SP of an R-TWT schedule.

The embodiments of the present disclosure further provide a negotiation apparatus for a latency sensitive traffic, applied to an AP device, including: a receiving module, configured to receive a first wireless frame, in which the first wireless frame includes first identifier information, and the first identifier information includes: a time parameter for transmitting the latency sensitive traffic between TDLS devices via a TDLS link within an R-TWT SP of an R-TWT schedule.

In an optional embodiment, the embodiments of the present disclosure further provide an electronic device, as shown in FIG. 8, an electronic device 800 shown in FIG. 8 may be a server, including: a processor 801 and a memory 803. The processor 801 is connected with the memory 803, for example, via a bus 802. Optionally, the electronic device 800 may further include a transceiver 804. It needs to be noted that, in a practical application, there may be more than one transceiver 804, and a structure of the electronic device 800 does not constitute a limitation to the embodiments of the present disclosure.

The processor 801 may be a central processing unit (CPU), a general-purpose processor, a digital signal processor (DSP), an application specific integrated circuit (ASIC), a field programmable gate array (FPGA), or other programmable logic devices, transistor logic devices, hardware components, or any combination thereof. The processor may implement or execute various exemplary logic blocks, modules, and circuits described in combination with the present disclosure. The processor 801 may also be a combination for realizing a computing function, for example, including a combination of one or more microprocessors, a combination of a DSP and a microprocessor, etc.

The bus 802 may include a pathway for transmitting information among above components. The bus 802 may be a peripheral component interconnect (PCI) bus, an extended industry standard architecture (EISA) bus, or the like. The bus 802 may be divided into an address bus, a data bus, a control bus, and the like. For ease of description, in FIG. 8, the bus 802 is shown as one thick line, which does not mean there is only one bus or one type of bus.

The memory 803 may be a read-only memory (ROM) or other type of static storage device capable of storing static information and instructions, a random access memory (RAM) or other type of dynamic storage device capable of storing information and instructions, an electrically erasable programmable read-only memory (EEPROM), a compact disc read-only memory (CD-ROM), other optical disc storage (including a compressed disc, a laser disc, an optical disc, a digital versatile disc, a blu-ray disc, etc.), a magnetic disk storage medium, other magnetic storage devices, or any other medium capable of carrying or storing program codes in a form of instructions or data structures and accessible by a computer, but is not limited thereto.

The memory 803 is configured to store application program codes for executing the solutions of the present disclosure and is controlled for execution by the processor 801. The processor 801 is configured to execute the application program codes stored in the memory 803 to implement content shown in the above method embodiments.

The electronic device includes but is not limited to: a mobile terminal, such as a mobile phone, a laptop, a digital broadcast receiver, a personal digital assistant (PDA), a PAD (tablet computer), a portable media player (PMP), a vehicle-mounted terminal (for example, vehicle-mounted navigation terminal), etc., and a fixed terminal, such as a digital TV, a desktop computer, etc. The electronic device shown in FIG. 8 is only an example and should not constitute any limitation on the functions and the scope of use of the embodiments of the present disclosure.

The server provided by the present disclosure may be an independent physical server, a server cluster or a distributed system composed of a plurality of physical servers, or a cloud server that provides a basic cloud computing service such as a cloud service, a cloud database, cloud computing, a cloud function, a cloud storage, a network service, a cloud communication, a middleware service, a domain name service, a security service, a content delivery network (CDN), big data and an artificial intelligence platform. The terminal may be a smartphone, a tablet computer, a laptop, a desktop computer, a smart speaker, a smart watch, etc., but is not limited thereto. The terminal and the server may be connected directly or indirectly via a wired or wireless communication manner, which is not limited in the present disclosure.

The embodiments of the present disclosure provide a computer-readable storage medium for storing a computer program that, when executed on a computer, causes the computer to perform corresponding content in the above method embodiments.

It may be understood that although steps in flowcharts of the accompanying drawings are displayed in order indicated by arrows, these steps are not necessarily executed in the order indicated by the arrows. Unless explicitly stated herein, there are no strict sequential constraints on execution of these steps, and they may be executed in another order. Moreover, at least some of the steps in the flowcharts of the accompanying drawings may include a plurality of sub-steps or stages, which are not necessarily executed at a same time but may be executed at different times. An execution order is not necessarily sequential, but may alternate with other steps or at least some of the sub-steps or stages of other steps.

It needs to be noted that above computer-readable storage medium in the present disclosure may be a computer-readable signal medium, a computer-readable storage medium, or any combination of them. The computer-readable storage medium may be, but is not limited to, an electrical, a magnetic, an optical, an electromagnetic, an infrared, or a semiconductor system, apparatus, or device, or any combination of them. More specific examples of the computer-readable storage medium may include, but are not limited to: an electrical connection with one or more wires, a portable computer disk, a hard disk, a RAM, a ROM, an erasable programmable read-only memory (EPROM or flash memory), an optical fiber, a portable CD-ROM, an optical storage device, a magnetic storage device, or any suitable combination of them. In the present disclosure, the computer-readable storage medium may be any tangible medium that includes or stores a program which may be used by or in connection with a system, an apparatus, or a component for executing instructions. In the present disclosure, the computer-readable signal medium may include a data signal propagated in a baseband or as a part of a carrier wave, in which computer-readable program codes are carried. A propagated data signal may take various forms, including but not limited to an electromagnetic signal, an optical signal, or any suitable combination of them. The computer-readable signal medium may also be any computer-readable storage medium other than a computer-readable storage medium, which may transmit, propagate, or transmit a program which may be used by or in connection with the system, the apparatus, or the device for executing the instructions. The program codes carried on the computer-readable storage medium may be transmitted using any appropriate medium, including but is not limited to: a wire, an optical cable, a radio frequency (RF), or any suitable combination of them.

The above computer-readable storage medium may be included in the electronic device, or may also exist independently without being installed in the electronic device.

The above computer-readable storage medium carries one or more programs. When the one or more programs are executed by the electronic device, the electronic device is caused to implement the method shown in the above embodiments.

According to one aspect of the present disclosure, a computer program product or a computer program is provided. The computer program product or the computer program includes computer instructions stored in the computer-readable storage medium. A processor of a computer reads the computer instructions from the computer-readable storage medium and executes the computer instructions, so that the computer may implement the method provided in various optional implementations described above.

A computer program code for executing operations of the present disclosure may be written in one or more programming languages or a combination of them. These programming languages include an object-oriented programming language such as Java, Smalltalk, and C++, and a conventional procedural programming language such as a “C” language or a similar programming language. The program code may be executed entirely on a user computer, partly on a user computer, as a dependent software package, partly on a user computer and partly on a remote computer, or entirely on a remote computer or a server. In a scenario involving the remote computer, the remote computer may be connected to the user computer via any type of network, including a local area network (LAN) or a wide area network (WAN), or to an external computer (e.g., via an Internet using an Internet service provider).

The flowcharts and block diagrams in the accompanying drawings show an architecture, a function, and an operation of possible implementations of the system, the method, and the computer program product according to various embodiments of the present disclosure. In this regard, each step in the flowchart or the block diagram may represent a module, a program segment, or a part of the code that includes one or more executable instructions for implementing a specified logical function. It also needs to be noted that, in some optional implementations, the functions noted in the steps may occur different from an order noted in the drawings. For example, two steps shown in succession may, in fact, be executed concurrently, or the steps may sometimes be executed in a reverse order, depending on a function involved. It also needs to be noted that each step of the block diagrams and/or the flowcharts, and a combination of the steps in the block diagrams and/or the flowcharts, may be implemented by a special-purpose hardware-based system that perform a specified function or operation, or by a combination of special-purpose hardware and computer instructions.

The modules in the embodiments of the present disclosure may be implemented in software or hardware. A name of the module does not, in some cases, constitute a limitation on the module itself. For example, a module may also be described as “a module for performing a B operation”.

The above description is merely preferred embodiments of the present disclosure and an explanation of a technical principle applied. Those skilled in the art should understand that a scope of the present disclosure is not limited to a technical solution formed by a specific combination of above technical features, but also includes other technical solutions formed by any combination of the above technical features or their equivalent features without departing from the principle of the present disclosure. For example, a technical solution formed by replacing above features with technical features, including (but are not limited to) those having similar functions, disclosed in the present disclosure.

1. A negotiation method for a latency sensitive traffic, applied to an access point (AP) device, comprising:
determining a first wireless frame, wherein the first wireless frame comprises first identifier information, and the first identifier information comprises: a time parameter for transmitting the latency sensitive traffic between tunneled direct link setup (TDLS) devices via a TDLS link within a restricted target wake time (R-TWT) service period (SP) of an R-TWT schedule; and
sending the first wireless frame.

2. The method of claim 1, wherein the time parameter comprises at least one of: TDLS R-TWT offset information or TDLS R-TWT duration information,
wherein the TDLS R-TWT offset information identifies: within the R-TWT SP, a target offset time of a start time for transmitting the latency sensitive traffic between the TDLS devices via the TDLS link relative to a start time of the R-TWT SP; and
the TDLS R-TWT duration information identifies: within the R-TWT SP, a target duration for transmitting the latency sensitive traffic between the TDLS devices via the TDLS link.

3. The method of claim 1, wherein the first wireless frame comprises a target wake time (TWT) element;
the TWT element comprises: a broadcast TWT parameter set field;
the broadcast TWT parameter set field comprises: a restricted TWT information subfield; and
the first identifier information is carried in the restricted TWT information subfield.

4. The method of claim 3, wherein the first identifier information comprises TDLS R-TWT parameter information.

5. The method of claim 3, wherein
the broadcast TWT parameter set field comprises: a broadcast TWT information subfield;
the broadcast TWT information subfield comprises: an R-TWT schedule information subfield; and
the R-TWT schedule information subfield is set to a first parameter value, indicating that the R-TWT schedule supports transmitting the latency sensitive traffic between the TDLS devices within the R-TWT SP via the TDLS link.

6. The method of claim 1, wherein the first wireless frame comprises a beacon frame or a probe response frame.

7. The method of claim 1, comprising:
receiving and responding to a first TWT setup frame sent by a TDLS device;
wherein TWT request identifier information of the first TWT setup frame indicates that the first TWT setup frame is a TWT setup request, and the first TWT setup frame indicates that the TDLS device requests to become a member of the R-TWT schedule.

8. The method of claim 7, after receiving and responding to the first TWT setup frame sent by the TDLS device, comprising:
in response to a wake time of the R-TWT schedule arriving, sending a trigger frame to the TDLS device, wherein the trigger frame triggers the TDLS device to transmit the latency sensitive traffic.

9. A negotiation method for a latency sensitive traffic, applied to a tunneled direct link setup (TDLS) device, comprising:
receiving a first wireless frame, wherein the first wireless frame comprises first identifier information, and the first identifier information comprises: a time parameter for transmitting the latency sensitive traffic between TDLS devices via a TDLS link within a restricted target wake time (R-TWT) service period (SP) of an R-TWT schedule.

10. The method of claim 9, wherein the time parameter comprises at least one of: TDLS R-TWT offset information or TDLS R-TWT duration information, wherein the TDLS R-TWT offset information identifies: within the R-TWT SP, a target offset time of a start time for transmitting the latency sensitive traffic between the TDLS devices via the TDLS link relative to a start time of the R-TWT SP; and
the TDLS R-TWT duration information identifies: within the R-TWT SP, a target duration for transmitting the latency sensitive traffic between the TDLS devices via the TDLS link.

11. The method of claim 9, wherein the first wireless frame comprises a target wake time (TWT) element;
the TWT element comprises: a broadcast TWT parameter set field;
the broadcast TWT parameter set field comprises: a restricted TWT information subfield; and
the first identifier information is carried in the restricted TWT information subfield.

12. The method of claim 11, wherein the first identifier information comprises TDLS R-TWT parameter information.

13. The method of claim 11, wherein
the broadcast TWT parameter set field comprises: a broadcast TWT information subfield;
the broadcast TWT information subfield comprises: an R-TWT scheduled information subfield; and
the R-TWT scheduled information subfield is set to a first parameter value, indicating that the R-TWT schedule supports transmitting the latency sensitive traffic between the TDLS devices within the R-TWT SP via the TDLS link.

14. The method of claim 9, wherein the first wireless frame comprises a beacon frame or a probe response frame.

15. The method of claim 10, comprising:
sending a first TWT setup frame to an access point (AP) device, wherein TWT request identifier information of the first TWT setup frame indicates that the first TWT setup frame is a TWT setup request; and the first TWT setup frame indicates that the TDLS device requests to become a member of the R-TWT schedule; and
receiving a second TWT setup frame fed back from the AP device, wherein TWT request identifier information of the second TWT setup frame indicates that the second TWT setup frame is a TWT setup response; and the second TWT setup frame is sent in response to the first TWT setup frame.

16. The method of claim 15, after receiving the second TWT setup frame fed back from the AP device, comprising:
receiving a trigger frame sent by the AP device, wherein the trigger frame triggers the TDLS device to transmit the latency sensitive traffic; or
in response to a target time arriving, within the target duration, transmitting the latency sensitive traffic via the TDLS link, wherein the target time is a time after the start time of the R-TWT SP is offset by the target offset time.

17-19. (canceled)

20. An access point (AP) device, comprising: a memory, a processor, and a computer program stored on the memory and executable by the processor, wherein the processor, when executing the computer program, is caused to:
determine a first wireless frame, wherein the first wireless frame comprises first identifier information, and the first identifier information comprises: a time parameter for transmitting the latency sensitive traffic between tunneled direct link setup (TDLS) devices via a TDLS link within a restricted target wake time (R-TWT) service period (SP) of an R-TWT schedule; and
send the first wireless frame.

21. A non-transitory computer-readable storage medium for storing a computer program that, when executed by a processor, causes the processor to implement the method of claim 1.

22. A tunneled direct link setup (TDLS) device, comprising: a memory, a processor, and a computer program stored on the memory and executable by the processor, wherein the processor, when executing the computer program, implements the method of claim 9.

23. A non-transitory computer-readable storage medium for storing a computer program that, when executed by a processor, causes the processor to implement the method of claim 9.
